(19) United States
(12) Patent Application Publication
(10) Pub. No.: US 2025/0284911 A1
(43) Pub. Date: Sep. 11, 2025

(54) PRINTING SYSTEM

(71) Applicant: MIMAKI ENGINEERING CO., LTD., Nagano (JP)

(72) Inventors: Wataru Arai, Nagano (JP); Wataru Hioki, Nagano (JP)

(73) Assignee: MIMAKI ENGINEERING CO., LTD., Nagano (JP)

(21) Appl. No.: 18/859,990

(22) PCT Filed: Apr. 27, 2023
(86) PCT No.: PCT/JP2023/016560

§ 371 Date: Oct. 24, 2024

(30) Foreign Application Priority Data
Apr. 28, 2022 (JP) 2022-075053

(51) Int. Cl. G06K 15/02; B41J 3/407; B41J 11/00

(52) U.S. Cl. CPC G06K 15/021; B41J 3/40731; B41J 3/40733; B41J 11/008; G06K 15/1842; G06K 15/1849

(57) ABSTRACT

To suppress distortion in an image formed on a tapered printing target object. A printing system includes: a printing device that rotates a tapered printing target object about an axial rotation direction of the central axis and ejects an ink to the side surface of the printing target object, and a control unit that forms an image on the printing target object based on supplied print data; and a print data generation device that acquires a rectangular original image, generates an image for printing deformed in the lateral direction in such a manner that the acquired original image is tapered from a second edge side corresponding to the small-diameter-side end portion of the printing target object to a first edge side corresponding to the large-diameter-side end portion of the printing target object, and supplies the image for printing generated to the printing device as print data.

### CROSS-REFERENCE TO RELATED APPLICATION

This application is a 371 application of the International PCT application serial no. PCT/JP2023/016560 filed on Apr. 27, 2023, which claims the priority benefit of Japan Patent Application No. 2022-075053 filed on Apr. 28, 2022. The entirety of each of the above-mentioned patent applications is hereby incorporated by reference herein and made a part of this specification.

### BACKGROUND

### Technical Field

The present disclosure relates to a printing system.

### Background Art

A printing device that forms an image by ejecting ink onto a side surface of a truncated cone-shaped printing target object is known (See, for example, Patent Literature 1).

### CITATION LIST

### Patent Literature

Patent Literature 1: Japanese Unexamined Patent Publication No. 2010-094882

### SUMMARY OF DISCLOSURE

### Technical Problems

In a case of printing a rectangular image on a side surface of a truncated cone-shaped printing target object, a moving distance per rotation is different between a large diameter side and a small diameter side, and thus distortion may occur in a printed image.

The present disclosure has been made in diagram of the above, and an object thereof is to provide a printing system capable of suppressing distortion in an image formed on a tapered printing target object.

### SUMMARY

A printing system according to the present disclosure includes: a printing device including a rotation support unit that rotates a tapered printing target object having a large-diameter-side end portion and a small-diameter-side end portion in an axial direction of a central axis about an axial rotation direction of the central axis, a head that is arranged along a side surface of the printing target object, includes a plurality of nozzles aligned along a generatrix direction of the printing target object, and ejects an ink from the nozzles to the side surface of the printing target object, and a control unit that controls the rotation support unit and the head to form an image on the printing target object based on supplied print data; and a print data generation device that acquires a rectangular original image having two edges facing each other in a longitudinal direction corresponding to the generatrix direction of the printing target object, and two edges facing each other in a lateral direction orthogonal to the longitudinal direction, generates an image for printing deformed in the lateral direction in such a manner that, for two edges facing each other in the longitudinal direction of the original image acquired, the original image acquired is tapered from a second edge side corresponding to the small-diameter-side end portion of the printing target object to a first edge side corresponding to the large-diameter-side end portion of the printing target object, and supplies the image for printing generated to the printing device as print data.

In the above printing system, the print data generation device may generate an intermediate image trapezoidal in which deletion regions have been deleted from the original image by setting the deletion regions including both ends of the second edge in such a manner that, for the two edges facing each other in the longitudinal direction of the original image acquired, the original image acquired is tapered from a first edge side corresponding to the large-diameter-side end portion of the printing target object to a second edge side corresponding to the small-diameter-side end portion of the printing target object, and generate the image for printing by deforming the intermediate image in the lateral direction so that the intermediate image trapezoidal has a rectangular shape.

In the above printing system, the print data generation device may set dimensions of the deletion regions based on a diameter of each of the large-diameter-side end portion and the small-diameter-side end portion of the printing target object and a length of a generatrix of the printing target object.

In the above printing system, the print data generation device may set dimensions of the deletion regions in such a manner that, in the original image, a main region to be printed remains in a visually recognizable range in a case where a side surface of the printing target object is viewed from one direction orthogonal to the central axis.

In the above printing system, the print data generation device may acquire a plurality of divided images by dividing the original image acquired in the lateral direction, and generate the image for printing by deforming each of a plurality of the divided images in the lateral direction in such a manner that each of a plurality of the divided images is tapered from the second edge side to the first edge side.

In the above printing system, the print data generation device may generate a divided intermediate image trapezoidal in which divided deletion regions have been deleted from each of the divided images by setting the divided deletion regions including both ends of the second edge in such a manner that, for two edges facing each other in the longitudinal direction of each of the divided images acquired, each of the divided images acquired is tapered from the first edge side to the second edge side, and generate the image for printing by deforming the divided intermediate image in the lateral direction so that the divided intermediate image trapezoidal has a rectangular shape.

In the above printing system, in a case where the original image acquired includes a main target image and a background image, the print data generation device may generate the image for printing by deforming the main target image and the background image separately in the lateral direction in such a manner that each of the main target image and the background image is tapered from the second edge side to the first edge side.

### Effect of the Disclosure

According to the present disclosure, it is possible to provide a printing system capable of suppressing distortion in an image formed on a tapered printing target object.

### BRIEF DESCRIPTION OF THE DRAWINGS

FIG. 1 is a diagram schematically illustrating one example of a printing system according to the present embodiment.

FIG. 2 shows diagrams schematically illustrating one example of a case of arranging a truncated cone-shaped printing target object on a printing device.

FIG. 3 shows diagrams illustrating one example of a head of the printing device.

FIG. 4 is a diagram illustrating one example of a printing operation of the printing device in a case where inks of a plurality of colors are used.

FIG. 5 is a diagram illustrating one example of a printing operation of the printing device in a case where inks of a plurality of colors are used.

FIG. 6 is a diagram illustrating one example of a printing operation of the printing device in a case where inks of a plurality of colors are used.

FIG. 7 shows diagrams schematically illustrating a process of generating print data.

FIG. 8 shows diagrams illustrating one example of a printing target object on which an image is formed.

FIG. 9 shows diagrams for comparing images to be printed on a truncated cone-shaped printing target object.

FIG. 10 shows diagrams illustrating another example of the process of generating print data.

FIG. 11 shows diagrams illustrating another example of the process of generating print data.

FIG. 12 shows diagrams illustrating another example of the process of generating print data.

FIG. 13 shows diagrams schematically illustrating a configuration of a printing system according to a modification.

### DESCRIPTION OF EMBODIMENTS

Hereinafter, embodiments of a printing system according to the present disclosure will be described with reference to the drawings. Note that the present disclosure is not limited by the embodiments. In addition, constituent elements in the following embodiments include those that can be easily replaced by those skilled in the art or those that are substantially the same.

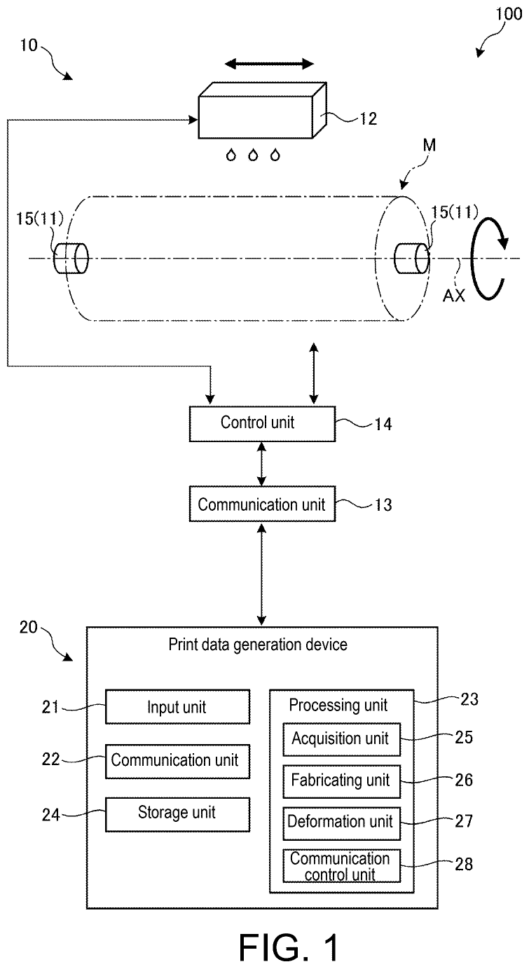

FIG. 1 is a diagram schematically illustrating one example of a printing system 100 according to the present embodiment. As illustrated in FIG. 1, the printing system 100 includes a printing device 10 and a print data generation device 20.

The printing device 10 includes a rotation support unit 11, a head 12, a communication unit 13, and a control unit 14. The printing device 10 can print an image on a side surface of the printing target object M having a rotating body shape such as a cylindrical shape or a truncated conical shape.

The rotation support unit 11 supports the printing target object M and rotates the printing target object M in an axial rotation direction of a central axis AX. The rotation support unit 11 supports the printing target object M in such a manner that a side surface M3 of the printing target object M has a head gap uniform or substantially uniform with respect to the head 12. The rotation support unit 11 supports the printing target object M in such a manner that two columnar members 15 sandwich the printing target object M from both sides in the axial direction of the central axis AX. The rotation support unit 11 can be rotated in the axial rotation direction of the central axis AX by a driving mechanism (not illustrated). For example, in a case where the printing target object M has one end portion in a concave shape like a cup shape, a fixing jig may be attached to the rotation support unit 11, and the outer peripheral portion of the concave end portion may be fixed by the fixing jig.

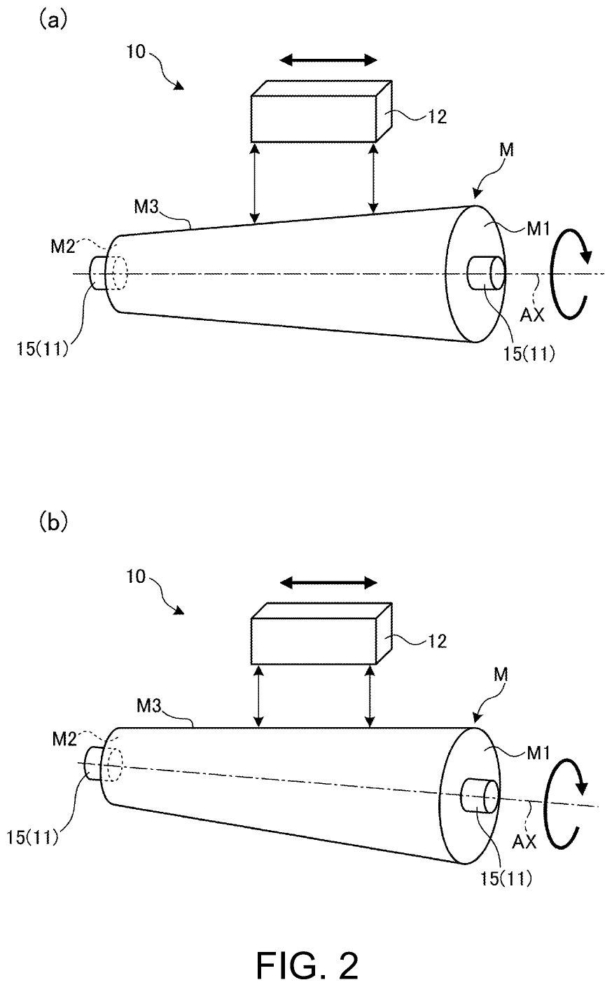

FIG. 2 shows diagrams schematically illustrating one example of a case of arranging a truncated cone-shaped printing target object M on the printing device 10. As illustrated in (a) and (b) of FIG. 2, the rotation support unit 11 can adjust an inclination of the two columnar members 15 with respect to a horizontal plane. In a case where the rotation support unit 11 rotates the truncated cone-shaped printing target object M having a large-diameter-side end portion M1 and a small-diameter-side end portion M2 in the axial direction of the central axis AX about the axial rotation direction of the central axis AX, the rotation support unit 11 supports and rotates the printing target object M, in a state where the central axis AX is inclined, in such a manner that the distance between the head 12 and the side surface M3 of the printing target object M becomes uniform or substantially uniform in a generatrix direction of the printing target object M. In this case, as illustrated in (b) of FIG. 2, the rotation support unit 11 is arranged in a state where the central axes of the two columnar members 15 are inclined with respect to the horizontal plane.

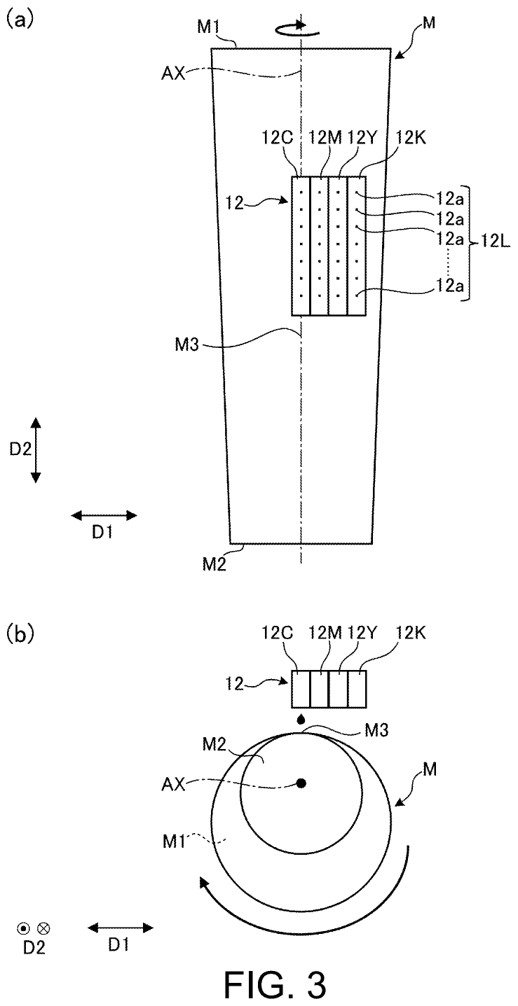

The head 12 is arranged along the side surface M3 of the printing target object M. The head 12 can move along the generatrix direction of the printing target object M. FIG. 3 shows diagrams illustrating one example of the head 12 of the printing device 10. In FIG. 3, (a) illustrates a state viewed from the upper side (although nozzles are not visible when viewed from above, nozzle rows are illustrated as points for the sake of description), and (b) of FIG. 3 illustrates a state viewed from the generatrix direction of the printing target object M.

As illustrated in (a) and (b) of FIG. 3, the head 12 includes ejection units 12C, 12M, 12Y, and 12 K that eject inks of different colors. The ejection unit 12C ejects, for example, cyan ink. The ejection unit 12M ejects, for example, magenta ink. The ejection unit 12Y ejects, for example, yellow ink. The ejection unit 12K ejects, for example, black ink. As illustrated in (a) of FIG. 3, each of the ejection units 12C, 12M, 12Y, and 12K includes a plurality of nozzles 12a. The plurality of nozzles 12a are arranged in one row along the generatrix direction of the printing target object M to constitute one nozzle row 12L. Each of the ejection units 12C, 12M, 12Y, 12K causes one nozzle row 12L to correspond to the central axis AX in the plan view, and ejects the ink from the plurality of nozzles 12a toward the side surface M3 of the printing target object M.

When forming an image on the printing target object M, as illustrated in (b) of FIG. 3, the ink is ejected one color at a time while rotating the printing target object M. In other words, among the plurality of nozzles 12a, the ink is ejected from the plurality of nozzles 12a of the ejection units 12C, 12M, 12Y, and 12K that correspond to the color to be ejected. In this case, one rotation of the printing target object M forms a one-color image.

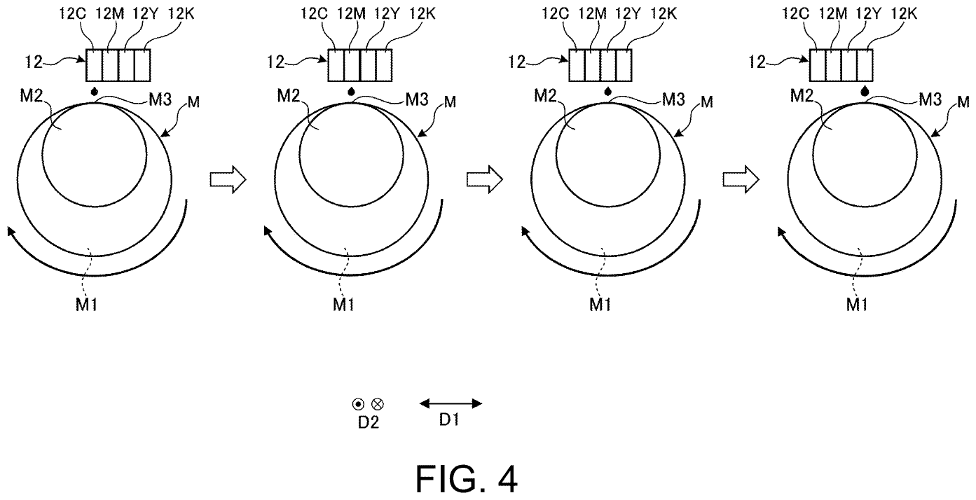

FIG. 4 is a diagram illustrating one example of a printing operation of the printing device in a case where inks of a plurality of colors are used. As illustrated in FIG. 4, the printing system 100 sequentially ejects one color at a time onto the printing target object M. For example, the ejection unit 12C is arranged at a position corresponding to the generatrix of the printing target object M, and the cyan ink is ejected from the nozzles 12a of the ejection unit 12C while the printing target object M is subjected to one rotation. Here, one rotation is a rotation for printing in a region corresponding to the entire region of the image to be formed on the printing target object M, and the moving distance is a rotation of one turn or less about the axial rotation direction of the central axis AX. Next, the head is moved in the main scanning direction DI to arrange the ejection unit 12M at the position corresponding to the generatrix of the printing target object M, and the magenta ink is ejected from the nozzles 12a of the ejection unit 12M while the printing target object M is subjected to one rotation. Next, the head is moved in the main scanning direction D1 to arrange the ejection unit 12Y at the position corresponding to the generatrix of the printing target object M, and the yellow ink is ejected from the nozzles 12a of the ejection unit 12Y while the printing target object M is subjected to one rotation. Then, the head is moved in the main scanning direction D1 to arrange the ejection unit 12K at the position corresponding to the generatrix of the printing target object M, and the black ink is ejected from the nozzles 12a of the ejection unit 12K while the printing target object M is subjected to one rotation. The rotation speed of the printing target object M is adjusted in accordance with the ejection speed of the ink.

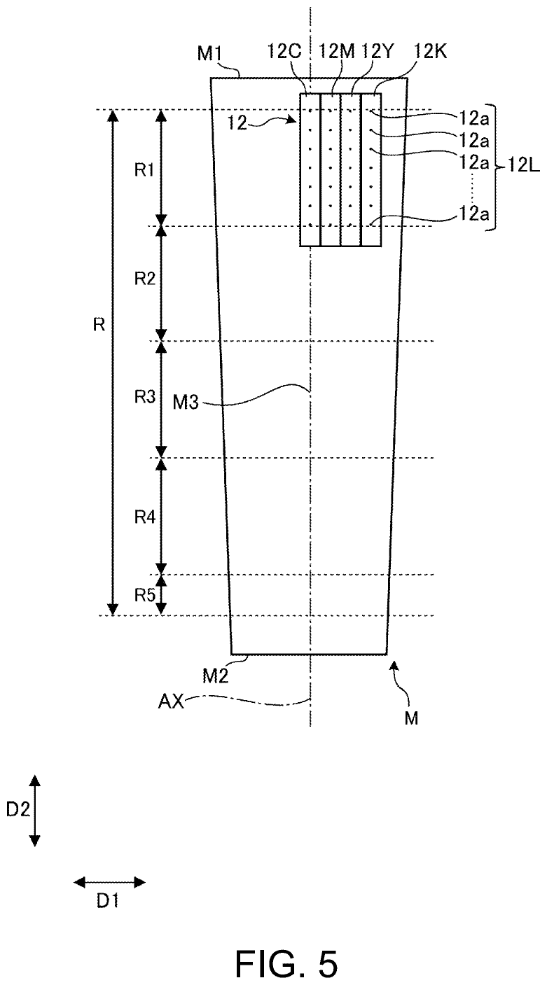

FIG. 5 is a diagram illustrating one example of a printing operation of the printing device in a case where inks of a plurality of colors are used. As illustrated in FIG. 5, the length of one nozzle row 12L in the sub-scanning direction D2 is shorter than the length of the printing target range R in the generatrix direction of the printing target object M. Therefore, the printing target region R of the printing target object M is divided into a plurality of pass regions R1 to R5 in the sub-scanning direction D2, and ejection is sequentially performed to the pass regions R1 to R5. The dimension of each of the pass regions R1 to R5 in the sub-scanning direction D2 is equal to or less than the length of the nozzle row 12L. In the example illustrated in FIG. 5, the dimension of each of the pass regions R1 to R4 in the sub-scanning direction D2 is the same as or substantially the same as the length of the nozzle row 12L. The dimension of the pass region R5 in the sub-scanning direction D2 is shorter than the length of the nozzle row 12L.

As illustrated in FIG. 5, the printing system 100 sequentially performs printing in the pass regions R1 to R5 with the ejection units 12C, 12M, 12Y, and 12K. That is, after printing is performed by each of the ejection units 12C, 12M, 12Y, and 12 K for the first pass region R1, printing is performed by each of the ejection units 12C, 12M, 12Y, and 12K for the next pass region R2. Thereafter, for the pass regions R3, R4, and R5, printing is sequentially performed by each of the ejection units 12C, 12M, 12Y, and 12K. In the printing in the pass region R5, the ink is ejected from part of the nozzles 12a of the nozzle row 12L corresponding to the dimension of the pass region R5 in the sub-scanning direction D2.

In the example illustrated in FIG. 5, a case where the printing is performed by the ejection units 12C, 12M, 12Y, and 12 K in order from the pass region R1 to the pass region R5 has been described, and the present disclosure is not limited thereto. For example, each of the pass regions R1 to R5 may be sequentially printed for one color, and then each of the pass regions R1 to R5 may be printed for the next color.

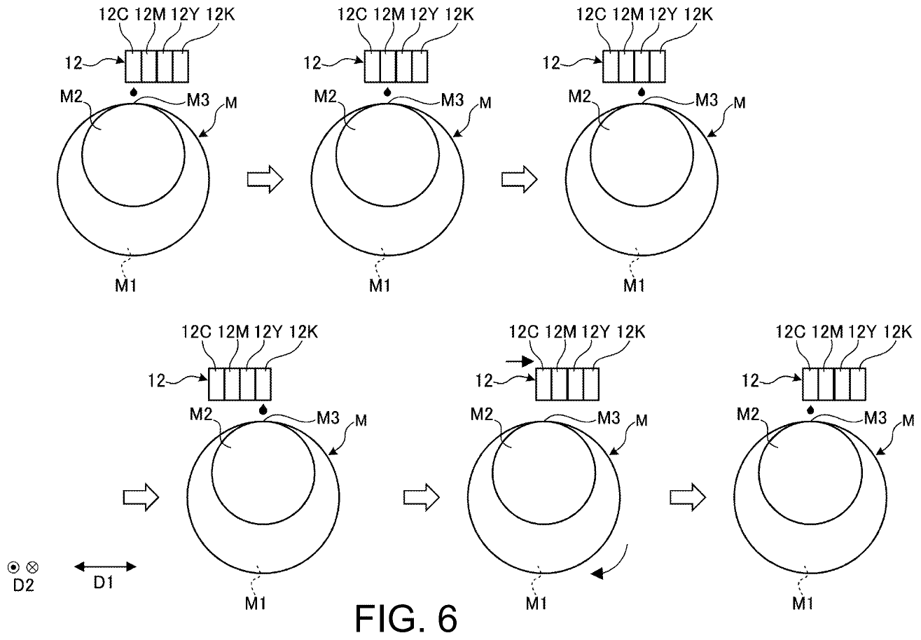

FIG. 6 is a diagram illustrating another example of a printing operation of the printing device when inks of a plurality of colors are used. As illustrated in FIG. 6, the ink may be sequentially ejected to the pass regions R1 to R5 one color at a time for each nozzle row 12L of one row. In this case, after ejecting the ink of one color to one pass region, the head 12 is moved in the sub-scanning direction D2 and eject the ink to the next pass region. After the ink of one color is sequentially ejected to the pass regions R1 to R5 in this manner, the head 12 is moved in the sub-scanning direction D2 to return to the initial pass region, and the head 12 is further moved in the main scanning direction D1 to arrange each of the ejection units 12C, 12M, 12Y, and 12K corresponding to the ink of the next color at the position corresponding to the generatrix of the printing target object M. Thereafter, the ink of the next color is sequentially ejected to the pass regions R1 to R5. This operation is performed for each color. After ejecting one row of ink in each of the pass regions R1 to R5 for all colors, the printing target object M is rotationally moved by a predetermined distance, and the head 12 is moved to a position corresponding to the initial color.

Returning to FIG. 1, the communication unit 13 receives the print data transmitted from a print data generation device 20. The communication unit 13 inputs the received print data to the control unit 14.

Print data is input to the control unit 14. The control unit 14 controls the rotation support unit 11 and the head 12 to form an image on the printing target object M according to the input print data.

The print data generation device 20 generates print data corresponding to an image to be formed on the printing target object M, and supplies the generated print data to the printing device 10.

The print data generation device 20 includes an input unit 21, a communication unit 22, a processing unit 23, and a storage unit 24.

Various types of information are input to the input unit 21. Operation contents by an operation device such as a keyboard, a mouse, or a touch panel are input to the input unit 21. The diameter of the large-diameter-side end portion M1 of the printing target object M, the diameter of the small-diameter-side end portion M2 of the printing target object M, and the length of the generatrix of the printing target object M can be input to the input unit 21.

The communication unit 22 can transmit and receive information to and from an external device. For example, the communication unit 22 can transmit print data to the printing device 10.

The processing unit 23 performs various processes. The processing unit 23 includes a processing device such as a central processing unit (CPU) and a storage device such as a random access memory (RAM) or a read only memory (ROM). The processing unit 23 includes an acquisition unit 25, a fabricating unit 26, a deformation unit 27, and a communication control unit 28.

The acquisition unit 25 acquires an original image to be printed on the printing target object M. In the present embodiment, the original image is a rectangular image having two edges facing each other in the longitudinal direction corresponding to the generatrix direction of the printing target object M and two edges facing each other in the lateral direction orthogonal to the longitudinal direction.

The fabricating unit 26 generates a trapezoidal intermediate image in such a manner that for the two edges facing each other in the longitudinal direction of the acquired original image, triangular deletion regions including both ends of a second edge corresponding to the small-diameter-side end portion M2 of the printing target object M are deleted so that the acquired original image is tapered from a first edge side corresponding to the large-diameter-side end portion Ml of the printing target object M to the second edge side corresponding to the small-diameter-side end portion M2 of the printing target object M.

The fabricating unit 26 sets the dimensions of the deletion regions based on the diameter of each of the large-diameter-side end portion M1 and the small-diameter-side end portion M2 of the printing target object M and the length of the generatrix of the printing target object M. The fabricating unit 26 sets the dimensions of the deletion regions in such a manner that, in the original image, a portion to be printed remains in a visually recognizable range in a case where the side surface M3 of the printing target object M is viewed from one direction orthogonal to the central axis AX.

The deformation unit 27 generates an image for printing by expanding the intermediate image in the lateral direction so that the trapezoidal intermediate image has a rectangular shape.

The communication control unit 28 controls the operation of the communication unit 22. The communication control unit 28 causes the printing device 10 to transmit the image for printing generated by the deformation unit 27 as print data.

The storage unit 24 stores various types of information. The storage unit 24 stores programs, data, and the like for performing each processing in the processing unit 23. The storage unit 24 includes, for example, a storage such as a hard disk drive or a solid state drive. Note that an external storage medium such as a removable disk may be used as the storage unit 24

Next, the operation of the printing system 100 will be described. As illustrated in (a) of FIG. 2, in the printing device 10, the printing target object M is supported by the rotation support unit 11. After the printing target object M is supported, as illustrated in (b) of FIG. 2, the inclination of the central axis AX of the printing target object M is adjusted so that the side surface M3 of the printing target object M faces the head 12 and the head gap is uniform or substantially uniform in the generatrix direction.

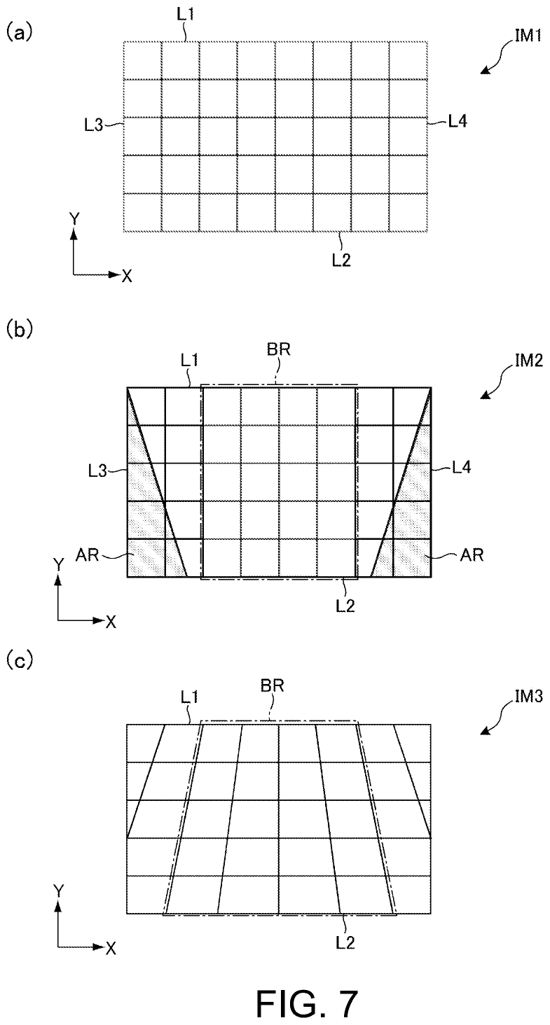

In the print data generation device 20, the diameter of each of the large-diameter-side end portion M1 and the small-diameter-side end portion M2 of the printing target object M and the length of the generatrix of the printing target object M are input via the input unit 21. FIG. 7 shows diagrams schematically illustrating a process of generating print data.

As illustrated in (a) of FIG. 7, the acquisition unit 25 acquires an original image IM1 to be printed on the side surface M3 of the printing target object M. The original image IM1 is an image having two edges (first edge L1, second edge L2) facing each other in the longitudinal direction Y corresponding to the generatrix direction of the printing target object M and two edges (third edge L3 and fourth edge L4) facing each other in the lateral direction X orthogonal to the longitudinal direction Y. In the following description, the original image IM1 will be described using an image including a plurality of straight lines along the longitudinal direction Y and a plurality of straight lines along the lateral direction X as an example.

In the original image IM1, the first edge L1 side corresponds to the large-diameter-side end portion M1 side of the printing target object M, and the second edge L2 side corresponds to the small-diameter-side end portion M2 side of the printing target object M. That is, in a case of performing printing on the printing target object M, the first edge L1 side is arranged on the large-diameter-side end portion M1 side of the printing target object M, and the second edge L2 side is arranged on the small-diameter-side end portion M2 side of the printing target object M.

As illustrated in (b) of FIG. 7, the fabricating unit 26 generates the intermediate image IM2 by setting the deletion regions AR for the acquired original image IM1 and deleting the deletion regions AR from the original image IM1.

The fabricating unit 26 sets triangular deletion regions AR including both ends of the second edge L2 so that the original image IM1 is tapered from the first edge L1 side to the second edge L2 side of the original image IM1. The fabricating unit 26 sets the two deletion regions AR to have a shape symmetrical in the lateral direction. When setting the deletion regions AR, the fabricating unit 26 sets the dimensions of the deletion regions AR based on the diameter of each of the large-diameter-side end portion M1 and the small-diameter-side end portion M2 of the printing target object M input to the input unit 21 and the length of the generatrix of the printing target object M. The fabricating unit 26 sets the dimensions of the deletion regions AR in such a manner that, in the original image IM1, the main region BR to be printed remains in a visually recognizable range in a case where the side surface M3 of the printing target object M is viewed from one direction orthogonal to the central axis AX.

As illustrated in (c) of FIG. 7, the deformation unit 27 generates an image for printing IM3 obtained by expanding the intermediate image IM2 in the lateral direction so that the trapezoidal intermediate image IM2 has a rectangular shape. The image for printing IM3 is an image stretched outward in the lateral direction from the first edge L1 side to the second edge L2 side as compared with the original image IM1.

The communication control unit 28 causes the communication unit 22 to transmit the generated image for printing IM3 as print data to the printing device 10.

The printing device 10 receives the transmitted print data. The communication unit 13 inputs the received print data to the control unit 14. The control unit 14 controls the rotation support unit 11 and the head 12 to form an image on the printing target object M according to the input print data.

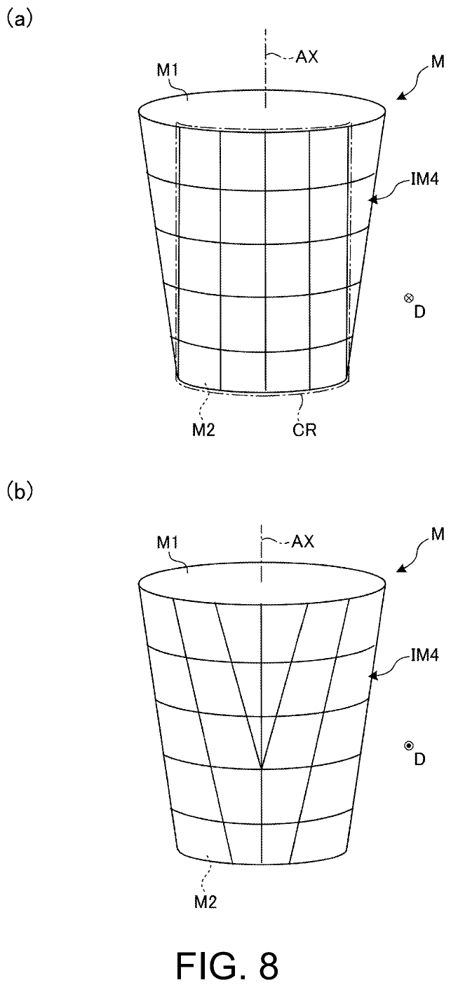

FIG. 8 shows diagrams illustrating one example of a printing target object M on which an image is formed. In FIG. 8, (a) illustrates a state where the printing target object M is viewed from a predetermined direction D orthogonal to the central axis AX of the printing target object M. In FIG. 8, (b) illustrates a state where the printing target object M is viewed from a direction opposite to the predetermined direction D described above.

As illustrated in (a) of FIG. 8, an image IM4 based on the image for printing IM3 is formed on the side surface M3 of the printing target object M. The side surface M3 is tapered from the large-diameter-side end portion M1 to the small-diameter-side end portion M2 of the printing target object M. The ink is ejected from the head 12 having the plurality of nozzles 12a arranged along the generatrix direction of the printing target object M onto such printing target object M. Therefore, as illustrated in (a) of FIG. 8, the image IM4 is formed in a state where the distortion in the circumferential direction is not visually recognized when viewed from the predetermined direction D. For example, in the image IM4 formed on the side surface M3, the corresponding portion CR corresponding to the main region BR of the image for printing IM3 is visually recognized without distortion over the entire axial direction of the central axis AX when viewed from the predetermined direction D. On the other hand, as illustrated in (b) of FIG. 8, in a case where the image IM4 is viewed from the side surface M3 of the printing target object M from the direction opposite to the predetermined direction D, the image IM4 is visually recognized in such a manner that distortion is formed in the circumferential direction in the axial direction of the central axis AX.

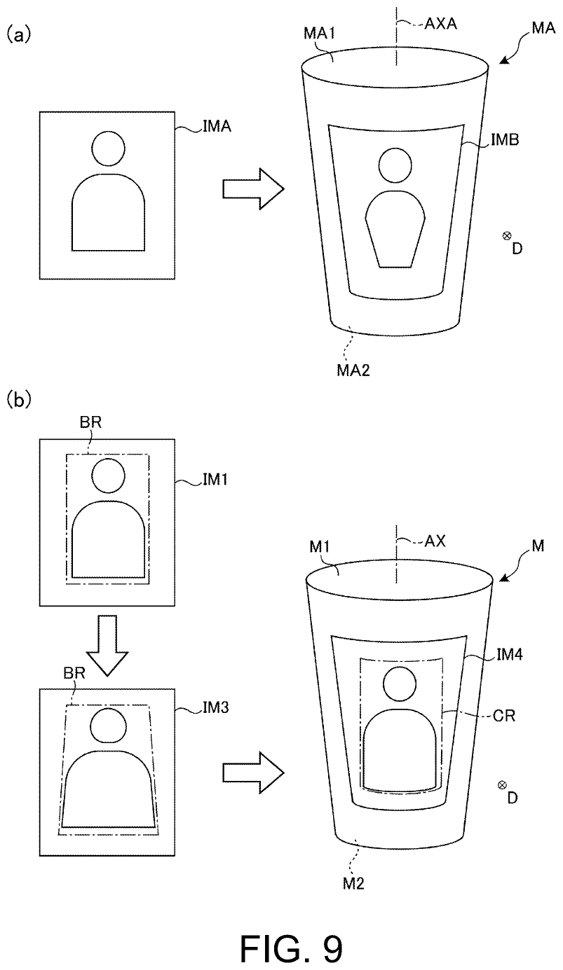

FIG. 9 shows diagrams for comparing images to be printed on a truncated cone-shaped printing target object. In FIG. 9, (a) illustrates a case where printing is performed on the printing target object MA according to a comparative example based on the rectangular original image IMA. As illustrated in (a) of FIG. 9, since the moving distance per rotation is different between the large diameter side and the small diameter side of the printing target object MA, the image IMB printed on the printing target object MA is formed in a state where the distortion in the circumferential direction increases from the large-diameter-side end portion MA1 to the small-diameter-side end portion MA2 in a case of being viewed from the direction orthogonal to the central axis AXA of the printing target object MA.

In FIG. 9, (b) illustrates a case where the image for printing IM3 is generated from the original image IM1 by the print data generation device 20 according to the present embodiment, and the image IM4 is formed on the printing target object M based on the generated image for printing IM3. As illustrated in (b) of FIG. 9, the image IM4 printed on the printing target object M is visually recognized in a state where the corresponding portion CR corresponding to the main region BR of the original image IM1 has no distortion in the circumferential direction over the entire axial direction of the central axis AX.

As described above, the printing system 100 according to the present embodiment includes: the printing device 10 including the rotation support unit 11 that rotates the tapered printing target object M having the large-diameter-side end portion M1 and the small-diameter-side end portion M2 in the axial direction of the central axis AX about the axial rotation direction of the central axis AX, the head 12 that includes a plurality of nozzles 12a arranged along the side surface M3 of the printing target object M and aligned along the generatrix direction of the printing target object M, and that ejects an ink from the nozzles 12a to the side surface M3 of the printing target object M, and the control unit 14 that controls the rotation support unit 11 and the head 12 to form an image on the printing target object M based on the supplied print data; and the print data generation device 20 that acquires a rectangular original image IM1 having two edges facing each other in the longitudinal direction Y corresponding to the generatrix direction of the printing target object M, and two edges facing each other in the lateral direction X orthogonal to the longitudinal direction Y, generates the image for printing IM3 deformed in the lateral direction X in such a manner that for the two edges facing each other in the longitudinal direction Y of the acquired original image IM1, the acquired original image is tapered from a second edge L2 side corresponding to small-diameter-side end portion M2 of the printing target object M to a first edge L1 side corresponding to the large-diameter-side end portion M1 of the printing target object M, and supplies the generated image for printing IM3 to the printing device 10 as print data.

According to this configuration, the rectangular original image IM1 is deformed in the lateral direction X to generate the rectangular image for printing IM3, and printing is performed by the printing device 10 based on the image for printing IM3. Therefore, the image to be printed on the printing target object M is suppressed from being distorted in the circumferential direction over the entire axial direction of the central axis AX. Thus, the distortion of the image formed on the tapered printing target object M can be suppressed.

In the printing system 100 according to the present embodiment, the print data generation device 20 generates the trapezoidal intermediate image IM2 in which the deletion regions AR have been deleted from the original image IM1 by setting the deletion regions AR including both ends of the second edge L2 in such a manner that, for the two edges facing each other in the longitudinal direction Y of the acquired original image, the acquired original image is tapered from the first edge L1 side corresponding to the large-diameter-side end portion M1 of the printing target object M to the second edge L2 side corresponding to the small-diameter-side end portion M2 of the printing target object M; and generates the image for printing IM3 by deforming the intermediate image IM2 in the lateral direction X so that the trapezoidal intermediate image IM2 has a rectangular shape.

According to this configuration, since the trapezoidal intermediate image IM2 in which the deletion regions AR have been deleted from the original image IM1 is generated by setting the deletion regions AR for the rectangular original image IM1, and the rectangular image for printing IM3 is generated by stretching the intermediate image IM2 in the lateral direction X, the image to be printed on the printing target object M is suppressed from having distortion in the circumferential direction over the entire axial direction of the central axis AX. Thus, the distortion of the image formed on the tapered printing target object M can be suppressed.

In the printing system 100 according to the present embodiment, the print data generation device 20 sets the dimensions of the deletion regions AR based on the diameter of each of the large-diameter-side end portion M1 and the small-diameter-side end portion M2 of the printing target object M and the length of the generatrix of the printing target object M. According to this configuration, the image for printing IM3 according to the diameter of the large-diameter-side end portion M1 of the printing target object M, the diameter of the small-diameter-side end portion M2 of the printing target object M, and the length of the generatrix on the side surface can be formed.

In the printing system 100 according to the present embodiment, the print data generation device 20 sets the dimensions of the deletion regions AR in such a manner that, in the original image IM1, the main region BR to be printed remains in a visually recognizable range in a case where the side surface M3 of the printing target object M is viewed from one direction orthogonal to the central axis AX. According to this configuration, it is possible to more reliably suppress distortion in the main region BR.

The technical scope of the present disclosure is not limited to the above embodiment, and can be appropriately changed without departing from the gist of the present disclosure. For example, in the embodiment described above, the configuration having the truncated conical shape has been described as an example of the printing target object M, and the disclosure is not limited thereto. The printing target object M may have another shape having a portion in which the diameter gradually decreases from the end portion on one side to the end portion on the other side of the central axis AX as long as the interval (head gap) between the printing target object M and the head 12 is within a predetermined allowable range in the generatrix direction.

Further, in the above embodiment, a case has been described as an example where the intermediate image IM2 in which the deletion regions AR have been deleted from the original image IM1 is generated and the image for printing IM3 is generated by deforming the intermediate image IM2 in the lateral direction, and the present disclosure is not limited to this procedure.

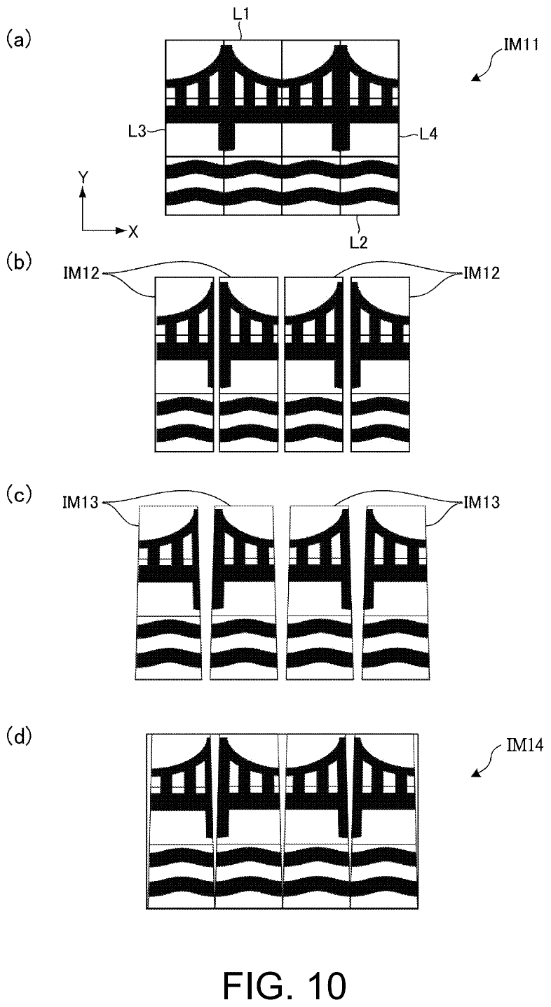

FIG. 10 shows diagrams illustrating another example of the process of generating print data. As illustrated in (a) of FIG. 10, the acquisition unit 25 acquires the original image IM11. The original image IM11 is an image having two edges (first edge L1, second edge L2) facing each other in the longitudinal direction Y corresponding to the generatrix direction of the printing target object M and two edges (third edge L3 and fourth edge L4) facing each other in the lateral direction X orthogonal to the longitudinal direction Y. In the following description, the original image IM11 will be described using a landscape image as an example.

In the original image IM11, the first edge L1 side corresponds to the large-diameter-side end portion M1 side of the printing target object M, and the second edge L2 side corresponds to the small-diameter-side end portion M2 side of the printing target object M. That is, in a case of performing printing on the printing target object M, the first edge L1 side is arranged on the large-diameter-side end portion M1 side of the printing target object M, and the second edge L2 side is arranged on the small-diameter-side end portion M2 side of the printing target object M.

As illustrated in (b) of FIG. 10, the fabricating unit 26 divides the acquired original image IM11 in the lateral direction X to acquire a plurality of divided images IM12.

As illustrated in (c) of FIG. 10, the deformation unit 27 expands each of the plurality of divided images IM12 in the lateral direction X in such a manner that each of the plurality of divided images IM12 is tapered from the second edge L2 side to the first edge L1 side, thereby generating a trapezoidal divided intermediate image IM13.

As illustrated in (d) of FIG. 10, the deformation unit 27 generates the image for printing IM14 by joining the plurality of divided intermediate images 13 in the lateral direction X. The image for printing IM14 is stretched outward in the lateral direction from the first edge L1 side to the second edge L2 side for each portion of the original image IM11.

As described above, the print data generation device 20 acquires a plurality of divided images IM12 by dividing the acquired original image IM11 in the lateral direction X, and generates the image for printing IM14 by deforming each of the plurality of divided images IM12 in the lateral direction X in such a manner that each of the plurality of divided images IM12 is tapered from the second edge L2 side to the first edge L1 side. As a result, the image for printing IM11 can be generated without deleting the deletion regions from the original image IM14.

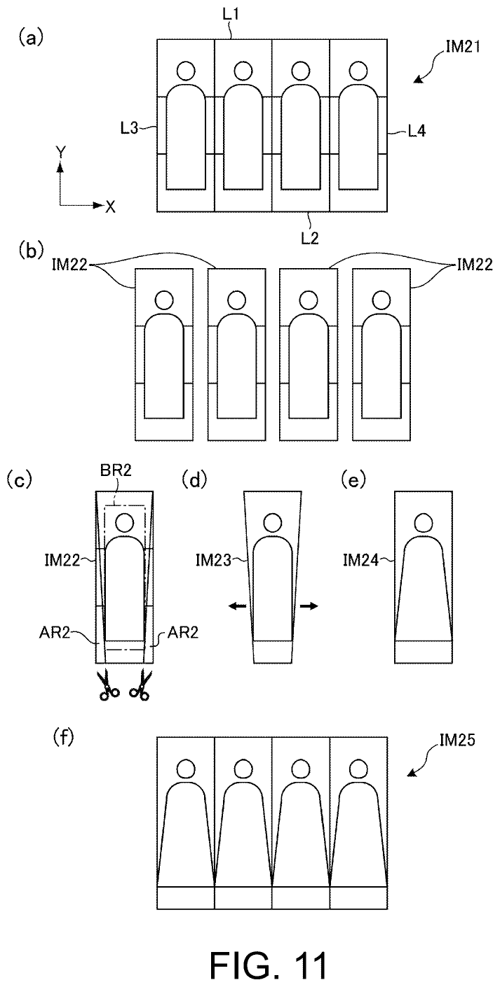

FIG. 11 shows diagrams illustrating another example of the process of generating print data. As illustrated in (a) of FIG. 11, the acquisition unit 25 acquires the original image IM21. The original image IM21 is an image having two edges (first edge L1, second edge L2) facing each other in the longitudinal direction Y corresponding to the generatrix direction of the printing target object M and two edges (third edge L3 and fourth edge L4) facing each other in the lateral direction X orthogonal to the longitudinal direction Y. In the following description, the original image IM21 will be described using a person image as an example.

In the original image IM21, the first edge L1 side corresponds to the large-diameter-side end portion Ml side of the printing target object M, and the second edge L2 side corresponds to the small-diameter-side end portion M2 side of the printing target object M. That is, in a case of performing printing on the printing target object M, the first edge L1 side is arranged on the large-diameter-side end portion M1 side of the printing target object M, and the second edge L2 side is arranged on the small-diameter-side end portion M2 side of the printing target object M.

As illustrated in (b) of FIG. 11, the fabricating unit 26 divides the acquired original image IM21 in the lateral direction X to acquire a plurality of divided images IM22.

As illustrated in (c) of FIG. 11, the deformation unit 27 sets the deletion regions AR2 for each of the plurality of acquired divided images IM22, and deletes the deletion regions AR2 from the divided image IM22 to generate the divided intermediate image IM23.

The deformation unit 27 sets triangular deletion regions AR2 including both ends of the second edge L2 side so that each of the plurality of divided images IM22 are tapered from the first edge L1 side to the second edge L2 side. The fabricating unit 26 sets the two deletion regions AR2 to have a shape symmetrical in the lateral direction. When setting the deletion regions AR2, the fabricating unit 26 sets the dimensions of the deletion regions AR2 based on the diameter of each of the large-diameter-side end portion M1 and the small-diameter-side end portion M2 of the printing target object M input to the input unit 21 and the length of the generatrix of the printing target object M. The fabricating unit 26 sets the dimensions of the deletion regions AR2 in such a manner that, in the original image IM21, the main region BR2 to be printed remains in a visually recognizable range in a case where the side surface M3 of the printing target object M is viewed from one direction orthogonal to the central axis AX.

As illustrated in (d) of FIG. 11, the deformation unit 27 generates a divided image for printing IM24 obtained by expanding the divided intermediate image IM23 in the lateral direction X so that the trapezoidal divided intermediate image IM23 has a rectangular shape.

The deformation unit 27 generates the image for printing IM25 by joining the generated divided image for printing IM24 in the lateral direction X. The image for printing 25 is stretched outward in the lateral direction from the first edge L1 side to the second edge L2 side for each portion of the original image IM21.

As described above, the print data generation device 20 generates the trapezoidal divided intermediate image IM23 in which the divided deletion regions AR2 have been deleted from the original image IM21 by setting the divided deletion regions AR2 including both ends of the second edge L2 in such a manner that, for the two edges facing each other in the longitudinal direction Y of each of the acquired divided image IM22, each of the acquired divided image IM22 are tapered from the first edge L1 side to the second edge L2 side, and generates the image for printing IM25 by deforming the divided intermediate image IM23 in the lateral direction X so that the trapezoidal divided intermediate image IM23 has a rectangular shape. As a result, in a case where the background or the like is not provided in the original image IM21 and the main region BR2 is allowed to remain, by deleting the divided image IM22 obtained by dividing the original image IM21, it is possible to generate the image for printing IM25 capable of appropriately suppressing the distortion in the image formed on the tapered printing target object M.

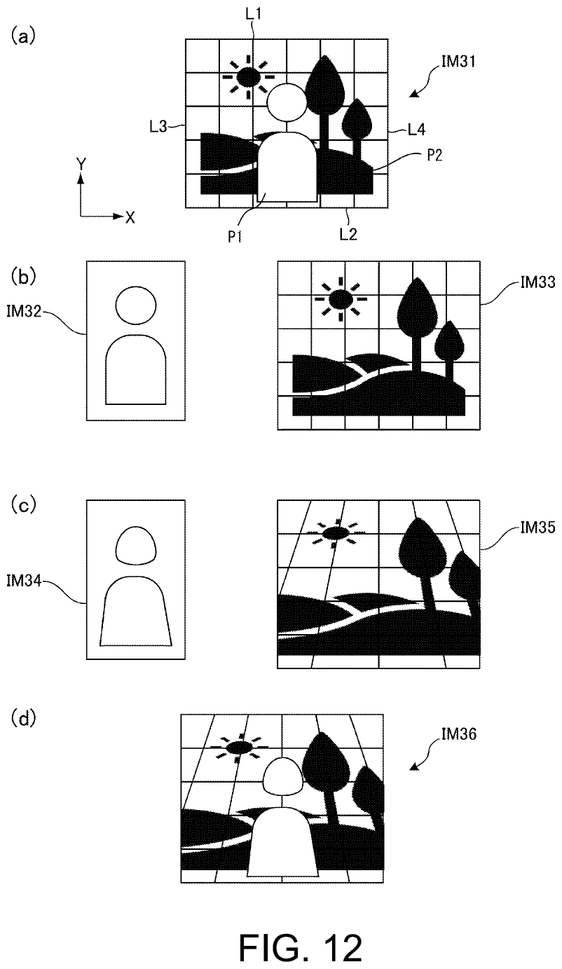

FIG. 12 shows diagrams illustrating another example of the process of generating print data. As illustrated in (a) of FIG. 12, the acquisition unit 25 acquires the original image IM31. The original image IM31 is an image having two edges (first edge L1, second edge L2) facing each other in the longitudinal direction Y corresponding to the generatrix direction of the printing target object M and two edges (third edge L3 and fourth edge L4) facing each other in the lateral direction X orthogonal to the longitudinal direction Y. In the following description, the original image IM31 including a main target image Pl such as a person and a background image P2 will be described as an example.

In the original image IM31, the first edge L1 side corresponds to the large-diameter-side end portion M1 side of the printing target object M, and the second edge L2 side corresponds to the small-diameter-side end portion M2 side of the printing target object M. That is, in a case of performing printing on the printing target object M, the first edge L1 side is arranged on the large-diameter-side end portion M1 side of the printing target object M, and the second edge L2 side is arranged on the small-diameter-side end portion M2 side of the printing target object M.

As illustrated in (b) of FIG. 12, the fabricating unit 26 acquires a plurality of separated images IM31 and IM32 obtained by separating the main target image P1 and the background image P2 from the acquired original image IM33. The separated image IM32 includes the main target image P1 and does not include the background image P2. The separated image IM33 does not include the main target image P1 and includes the background image P2.

As illustrated in (c) of FIG. 12, the deformation unit 27 generates the separated images for printing IM34 and IM35 deformed in such a manner that each of the plurality of acquired separated images IM32 and IM33 is tapered from the second edge L2 side to the first edge L1 side by, for example, a procedure similar to the procedure described in the above embodiment and the like.

As illustrated in (d) of FIG. 12, the deformation unit 27 generates the image for printing IM36 by combines the separated image for printing IM34 and the separated image for printing IM35.

As described above, in a case where the acquired original image IM31 includes the main target image P1 and the background image P2, the print data generation device 20 generates the image for printing IM36 by deforming the main target image P1 and the background image P2 separately in the lateral direction X in such a manner that each of the main target image P1 and the background image P2 is tapered from the second edge L2 side to the first edge L1 side. In a case where the main target image P1 and the background image P2 are included in the original image IM31, by separately deforming the main target image P1 and the background image P2, it is possible to generate the image for printing IM36 capable of more appropriately suppressing the distortion in the main target image P1 in the image formed on the tapered printing target object M.

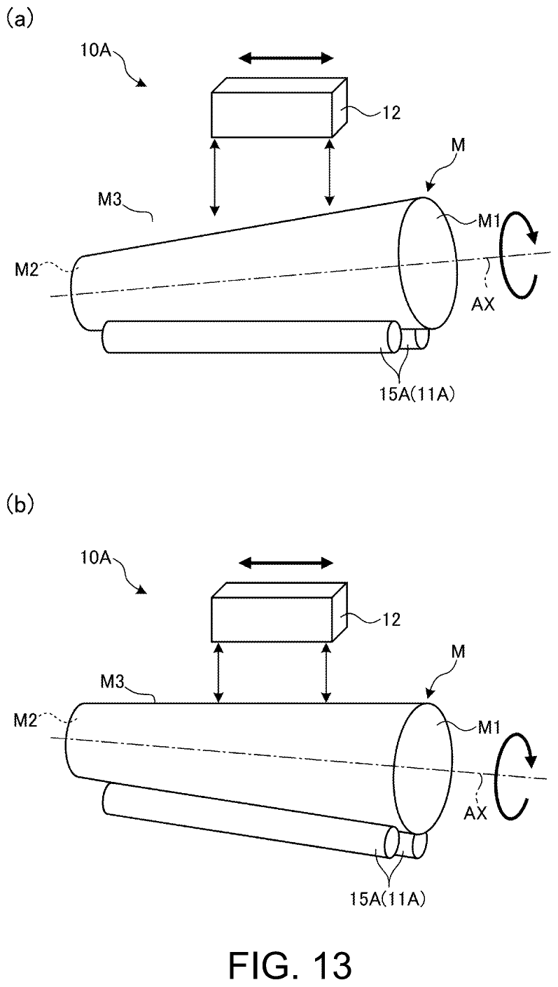

In the embodiment described above, the configuration in which the rotation support unit 11 supports the printing target object M in such a manner that the rotation support unit 11 sandwiches the printing target object M from both sides in the axial direction of the central axis AX has been described as an example, and the disclosure is not limited to this configuration. FIG. 13 shows diagrams schematically illustrating a configuration of a printing device 10A according to a modification. A printing device 10A illustrated in FIG. 13 includes a rotation support unit 11A and a head 12. The printing device 10A is different from the above-described embodiment in the configuration of the rotation support unit 11A, and the configuration of the head 12 is similar to the above-described embodiment.

As illustrated in FIG. 13, for example, the rotation support unit 11A is arranged in a state where two columnar members 15A are aligned. The rotation support unit 11A can support the printing target object M1 with the two columnar members 15A. In addition, in the rotation support unit 11A, each of the columnar members 15A can rotate about the axial rotation direction of the central axis. The rotation support unit 11A can rotate the printing target object M about the axial rotation direction of the central axis AX by rotating in a state where the two columnar members 15A support the printing target object M.

As illustrated in (a) and (b) of FIG. 13, the rotation support unit 11A can adjust an inclination of the two columnar members 15A with respect to a horizontal plane. The rotation support unit 11A supports and rotates the printing target object M, in a state where the central axis AX is inclined, in such a manner the distance between the head 12 and the side surface M3 of the printing target object M becomes uniform or substantially uniform in the generatrix direction of the printing target object M. In this case, as illustrated in (b) of FIG. 13, the rotation support unit 11A is arranged in a state where the central axes of the two columnar members 15A are inclined with respect to the horizontal plane.

1. A printing system comprising:
a printing device including
a rotation support unit that rotates a printing target object tapered having a large-diameter-side end portion and a small-diameter-side end portion in an axial direction of a central axis about an axial rotation direction of the central axis,
a head that is arranged along a side surface of the printing target object, includes a plurality of nozzles aligned along a generatrix direction of the printing target object, and ejects an ink from the plurality of nozzles to the side surface of the printing target object, and
a control unit that controls the rotation support unit and the head to form an image on the printing target object based on print data supplied; and
a print data generation device that acquires a rectangular original image having two edges facing each other in a longitudinal direction corresponding to the generatrix direction of the printing target object, and two edges facing each other in a lateral direction orthogonal to the longitudinal direction, generates an image for printing deformed in the lateral direction in such a manner that, for two edges facing each other in the longitudinal direction of the acquired original image, the acquired original image is tapered from a second edge side corresponding to the small-diameter-side end portion of the printing target object to a first edge side corresponding to the large-diameter-side end portion of the printing target object, and supplies the image for printing generated to the printing device as print data.

2. The printing system as set forth in claim 1, wherein the print data generation device generates an intermediate image trapezoidal in which deletion regions have been deleted from the acquired original image by setting the deletion regions including both ends of the second edge in such a manner that, for the two edges facing each other in the longitudinal direction of the acquired original image, the acquired original image is tapered from a first edge side corresponding to the large-diameter-side end portion of the printing target object to a second edge side corresponding to the small-diameter-side end portion of the printing target object; and generates the image for printing by deforming the intermediate image in the lateral direction so that the intermediate image trapezoidal has a rectangular shape.

3. The printing system as set forth in claim 2, wherein the print data generation device sets dimensions of the deletion regions based on a diameter of each of the large-diameter-side end portion and the small-diameter-side end portion of the printing target object and a length of a generatrix of the printing target object.

4. The printing system as set forth in claim 2, wherein the print data generation device sets dimensions of the deletion regions in such a manner that, in the acquired original image, a main region to be printed remains in a visually recognizable range in a case where a side surface of the printing target object is viewed from one direction orthogonal to the central axis.

5. The printing system as set forth in claim 1, wherein the print data generation device acquires a plurality of divided images by dividing the acquired original image in the lateral direction, and generates the image for printing by deforming each of the plurality of divided images in the lateral direction in such a manner that each of the plurality of divided images is tapered from the second edge side to the first edge side.

6. The printing system as set forth in claim 5, wherein the print data generation device generates a divided intermediate image trapezoidal in which divided deletion regions have been deleted from each of the divided images by setting the divided deletion regions including both ends of the second edge in such a manner that, for two edges facing each other in the longitudinal direction of each of the divided images acquired, each of the divided images acquired are tapered from the first edge side to the second edge side, and generates the image for printing by deforming the divided intermediate image in the lateral direction so that the divided intermediate image trapezoidal has a rectangular shape.

7. The printing system as set forth in claim 1, wherein the print data generation device generates, in a case where the acquired original image includes a main target image and a background image, the image for printing by deforming the main target image and the background image separately in the lateral direction in such a manner that each of the main target image and the background image is tapered from the second edge side to the first edge side.

8. The printing system as set forth in claim 3, wherein the print data generation device sets dimensions of the deletion regions in such a manner that, in the acquired original image, a main region to be printed remains in a visually recognizable range in a case where a side surface of the printing target object is viewed from one direction orthogonal to the central axis.
